(19) United States
(12) Patent Application Publication
(10) Pub. No.: US 2024/0402212 A1
(43) Pub. Date: Dec. 5, 2024

(54) SHOCK SEVERITY ESTIMATION SOLUTION FOR USE IN ASSET TRACKING

(71) Applicant: QUALCOMM Incorporated, San Diego, CA (US)

(72) Inventors: Justin CAUTHEN, Dungourney (IE); Sergi GOMEZ, Cork (IE); Nauman SHAHID, Cork (IE); Rashmi KULKARNI, Redwood City, CA (US); Ana LONDERGAN, Santa Clara, CA (US)

(21) Appl. No.: 18/325,395

(22) Filed: May 30, 2023

(51) Int. Cl. G01P 15/00; G01P 1/00; G06Q 10/0833

(52) U.S. Cl. CPC G01P 15/00; G01P 1/06; G06Q 10/0833

(57) ABSTRACT

Disclosed are systems, apparatuses, processes, and computer-readable media for estimating shock severity during handling or delivery of assets. For example, an example of a process includes capturing, by a device, a measured acceleration for an asset associated with the device; declipping, by the device, the measured acceleration for the asset to determine a reconstructed acceleration for the asset; determining, by the device, a velocity estimate for the asset based on the reconstructed acceleration; and determining, by the device, whether the asset has experienced a severe shock based on the velocity estimate.

### FIELD

The present disclosure generally relates to estimating shock severity during handling or delivery of assets. For example, aspects of the present disclosure are related to systems and techniques for a shock severity estimation solution for use in asset tracking by internet of things (IoT) devices, such as tracking devices.

### BACKGROUND

The shipping and delivery of assets (e.g., items or goods) is an important activity for many users (e.g., parcel owners), which may be affiliated with various different business organizations. Sensitive and expensive assets may experience a sudden acceleration (or deceleration) due to an interaction between an object and some force (e.g., which henceforth may be referred to as a shock) as a result of mishandling in a warehouse or during the transportation of the assets. Currently, manual inspections of the assets are carried out in order to detect and reject (or replace) any damaged assets (e.g., which have been damaged by experiencing a severe shock). The performance of manual inspections can be costly both in terms of time and money. As such, improved systems and techniques for estimating shock severity experienced by assets during the handling and delivery of the assets can be beneficial.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for a shock severity estimation solution for use in asset tracking. According to at least one example, a method of performing shock severity estimation performed by a device is provided. The method includes: capturing, by the device, a measured acceleration for an asset associated with the device; declipping, by the device, the measured acceleration for the asset to determine a reconstructed acceleration for the asset; determining, by the device, a velocity estimate for the asset based on the reconstructed acceleration; and determining, by the device, whether the asset has experienced a shock based on the velocity estimate.

In another illustrative example, an apparatus for shock severity estimation is provided. The apparatus includes at least one memory and at least one processor coupled to the at least one memory and configured to: capture a measured acceleration for an asset associated with the apparatus; declip the measured acceleration for the asset to determine a reconstructed acceleration for the asset; determine a velocity estimate for the asset based on the reconstructed acceleration; and determine whether the asset has experienced a shock based on the velocity estimate.

In another illustrative example, a non-transitory computer-readable storage medium of a device is provided comprising instructions stored thereon which, when executed by at least one processor, causes the at least one processor to: capture a measured acceleration for an asset associated with the device; declip the measured acceleration for the asset to determine a reconstructed acceleration for the asset; determine a velocity estimate for the asset based on the reconstructed acceleration; and determine whether the asset has experienced a shock based on the velocity estimate.

In another illustrative example, an apparatus for shock severity estimation is provided. The apparatus includes: means for capturing a measured acceleration for an asset associated with the apparatus; means for declipping the measured acceleration for the asset to determine a reconstructed acceleration for the asset; means for determining a velocity estimate for the asset based on the reconstructed acceleration; and means for determining whether the asset has experienced a shock based on the velocity estimate.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with aspects of the present disclosure.

FIG. 2 is a diagram illustrating an example of a network of trackers (e.g., tracking devices) on a delivery vehicle, in accordance with aspects of the present disclosure.

FIG. 3 is a graph illustrating an example of the magnitude of acceleration measured over time, in accordance with aspects of the present disclosure.

FIG. 4 is a diagram illustrating an example of a heavy box, with an associated tracking device, falling onto a steel box, in accordance with aspects of the present disclosure.

FIG. 5 is a graph illustrating an example of acceleration measured over time by the tracking device of FIG. 4, in accordance with aspects of the present disclosure.

FIG. 6 is a graph illustrating an example of impact velocity over time estimated by the tracking device of FIG. 4, in accordance with aspects of the present disclosure.

FIG. 7 is a table illustrating an example of estimating levels of shock severity based on different velocities, in accordance with aspects of the present disclosure.

FIG. 8 is a diagram illustrating an example of a process for estimating velocity from measured acceleration of an asset, in accordance with aspects of the present disclosure.

FIG. 9 is a diagram illustrating an example of a process for determining shock severity metrics for an asset, in accordance with aspects of the present disclosure.

FIG. 10 is a flow chart illustrating an example of a process for estimating shock severity, in accordance with aspects of the present disclosure.

FIG. 11 is a block diagram illustrating an example of a computing system, which may be employed by the disclosed systems and techniques, in accordance with aspects of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, the shipping and delivery of assets (e.g., items or goods) can be an important activity for many users, such as parcel owners, which may be affiliated with various different business organizations. Sensitive and expensive assets can experience high severity shocks as a result of mishandling in a warehouse or during the transportation of the assets. A high severity shock could be the result of, but not limited to, the asset experiencing a freefall and making impact with a hard surface, the asset experiencing a collision with a separate object, during which there was no freefall experienced by the tracked asset, a sudden acceleration or deceleration caused by an event or object near the asset, such as a vehicle collision or explosion, during which no impact was experienced by the tracked asset, any combination thereof, and/or other forms of shock. Currently, manual inspections of the assets are carried out in order to detect and reject, or replace, any damaged assets, which may have been damaged by experiencing a severe shock. Performing manual inspections can be costly both in terms of time and money. As such, improved systems and techniques for estimating shock severity experienced by assets during the handling and delivery of the assets can be useful.

In one or more aspects of the present disclosure, systems, apparatuses, methods (also referred to as processes), and computer-readable media (collectively referred to herein as “systems and techniques”) are described herein that provide for monitoring (e.g., a real-time monitoring) of assets (e.g., goods) to detect potential damage or mishandling of the assets. The assets can be expensive, sensitive, and/or fragile objects.

In some cases, the systems and techniques can provide a shock severity estimation feature on low power trackers (e.g., tracking devices) of assets that may help to significantly reduce the number of needed manual inspections of the assets. In one or more examples, velocity can be estimated by a tracker to determine the severity of a shock when measured acceleration was severely clipped. The velocity can be estimated by the tracker based on measured acceleration of the asset. In such cases, the tracker uses velocity, rather than acceleration, as a key shock severity metric.

When using velocity to determine shock severity for assets, shock severity estimates can still be accurate, even when the trackers are using accelerometers with low ranges (e.g., dynamic ranges) and low sampling rates. For example, the tracker can accurately determine a level of severity of shock experienced by an asset by using a 16 G accelerometer operating with a sampling rate of 100 Hertz (Hz). The systems and techniques for estimating shock severity for assets can effectively employ trackers with accelerometers with low ranges and low sampling rates, and thus can provide a solution that is low cost as well as efficient in power consumption. In one or more examples, the tracker can determine and communicate (e.g., to a user) temporal information, such as the time of impact and/or the duration of the shock, in addition to metrics, such as impact velocity and G-force impact.

Additional aspects of the present disclosure are described in more detail below with respect to the figures.

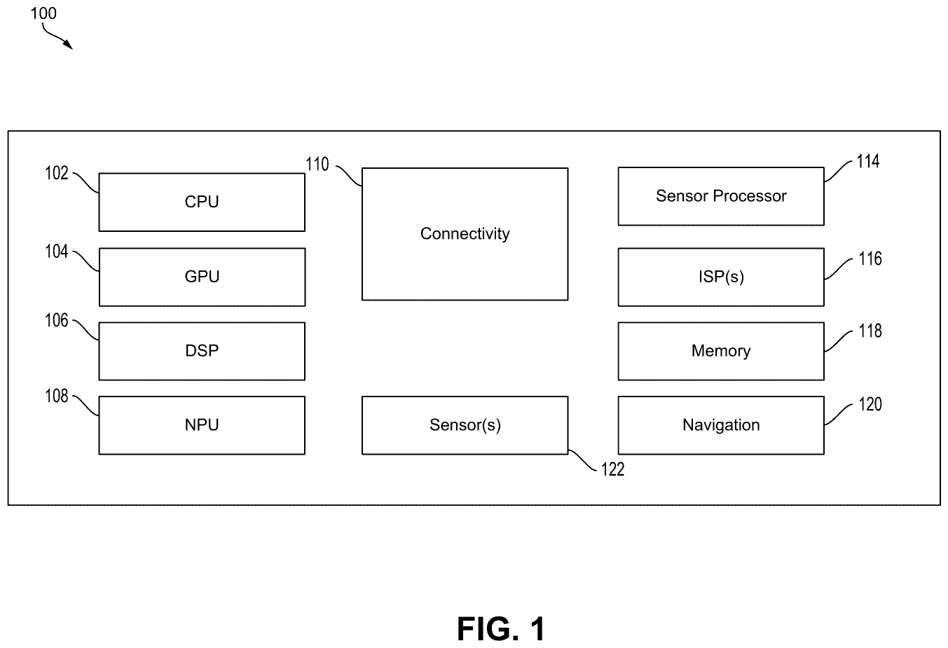

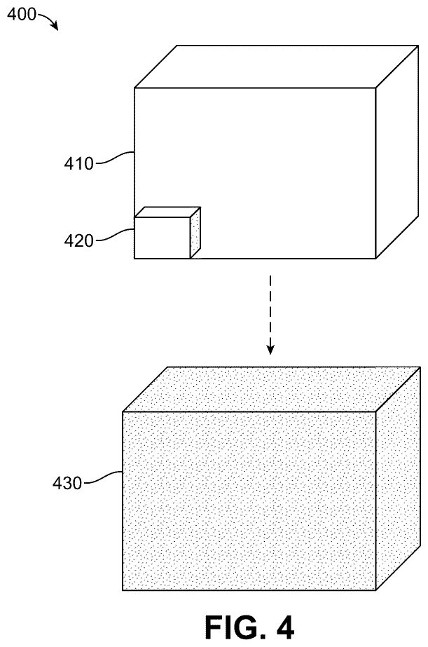

FIG. 1 illustrates an example implementation of a system-on-a-chip (SOC) 100, which may be employed for a tracking device (e.g., tracking device 420 of FIG. 4) for estimating shock severity during handling or delivery of assets. The SOC 100 can include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 102, DSP 106, and/or GPU 104. The SOC 100 may also include a sensor processor 114, image signal processors (ISPs) 116, and/or navigation module 120, which may include a global navigation satellite system (GNSS) and/or global positioning system (GPS).

SOC 100 and/or components thereof may be configured to evaluate environmental conditions. For example, the sensor processor 114 may receive and/or process information from one or more sensors 122. Examples of sensors 122 may include one or more Inertial Measurement Units (IMUs) (e.g., an accelerometer, a gyroscope, etc.), temperature sensors, light sensors, shock sensors, humidity sensors, acceleration sensors, speed sensors, tilt angle sensors, etc. sensors of a device. In some cases, the sensors 122 may be located on SOC 100. In other cases, the sensor processor 114 may also be coupled to one or more sensors (not shown) that are external to the SOC 100 (e.g., located on a separate chip). In some cases, the sensor processor 114 may also receive, as input, output of one or more processing blocks of the connectivity block 110.

Moving assets, such as goods, parts, materials, etc., between locations is increasingly an important part of the global economy as supply chains spread out across states, countries, and continents. As moving asserts becomes increasingly important, tracking shipped assets is also becoming to organizations as understanding when assets may arrive and in what condition those assets may be in can be useful for planning operations of the organizations.

To better track and understand environmental conditions assets may be exposed to as they move, sensor or asset tracking (e.g., tracker) devices (e.g., tracking devices) may be included with the assets. These trackers may sense the environment around the tracker, gather location information, sense events, and the like. In some cases, the trackers may also periodically report the sensed data. In some cases, trackers may perform non-sensing functionality, such as gathering data from other trackers, command and control operations, such as configuring trackers, scheduling operations of trackers, processing received data, transmitting data, and the like. In some cases, a tracker may include non-sensing functionality in addition to, or instead of the environmental sensing functionality. As the trackers may often be used to track moving assets, the trackers may be relatively low-powered, battery-operated devices. Additionally, trackers often may move in groups with multiple sensors distributed in strategic locations around the assets.

To help enhance battery life of trackers by distributing the activities of the trackers, the trackers may be organized in a network of trackers. The network of trackers may be dynamically formed by nearby trackers without a need for infrastructure support. In some cases, the network of trackers may use any mobile ad hoc network routing protocol, such as on-demand broadcast routing protocols, or routing table-based protocols. Additionally, a network of trackers may be formed across a heterogeneous network of smaller networks of trackers. In some cases, each network of trackers, including sub-networks of trackers, may use a different network routing protocol.

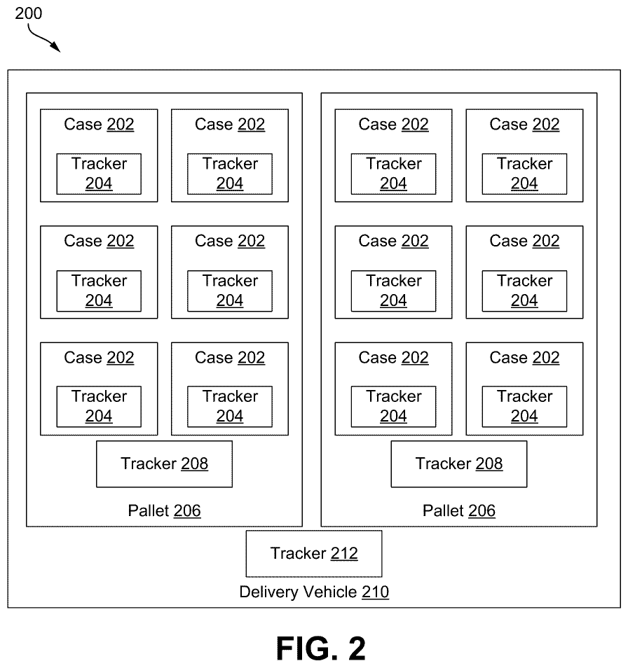

FIG. 2 is a diagram 200 illustrating an example network of trackers (e.g., tracking devices) on a delivery vehicle 210 (such as a delivery vehicle in the form of a truck, or an alternative delivery vehicle in the form of a drone). As shown in diagram 200, assets may be packed for shipping in one or more boxes or cases 202 (such as box 410 of FIG. 4). In some examples, trackers 204 (e.g., which may include one or more trackers, such as tracking device 420 of FIG. 4) may be included with the assets in a case 202, or trackers 204 may be distributed in a certain percentage of the cases 202. The trackers 204 distributed in the cases 202 may sense environmental conditions within the cases 202, location of the individual cases 202, distribution of the cases 202, and the like. These cases 202 may be loaded onto pallets 206. In some cases, trackers 208 may be included on a certain percentage of the pallets 206 and these trackers 208 may sense environmental conditions around the cases 202 and/or pallets 206, location of the pallets 206, distribution of the pallets 206, and the like. In some cases, a number of cases 202 per pallet 206 may be known in advance based on a size of the cases 202, carrying capacity of the pallet 206, etc. The pallets 206 may in turn be loaded into a shipping container (e.g., boxcar) on a delivery vehicle 210 (e.g., a truck, drone, and etc.). In some cases, trackers 212 may be included in, for example, the delivery vehicle 210 and these trackers 212 may sense environmental conditions within or around the delivery vehicle 210, location of the delivery vehicle 210, and the like.

In some cases, information gathered from the trackers, such as trackers 204, 208, and 212, may be reported to one or more remote servers (not shown). The remote servers may process the sensed data and provide the processed data to a user. In some cases, the remote servers may process the sensed data in addition to, or instead of, any processing of the data that may be performed by the trackers. In some cases, this processed data may be provided to a user in near real time and the processed data may be provided continuously, periodically, on a schedule, on-demand, or at any other rate. In some cases, the rate at which data may be provided from the trackers 204 may be adjusted dynamically based on customer demands and hardware capability. As the trackers (e.g., trackers 204, 208, and 212) may be relatively low power devices, there may be a trade-off between sensing and reporting activities with battery life or tracker costs. Additionally, some activities, such as receiving and processing sensing data from other trackers or transmitting data to remote servers, may use more battery power than other activities, such as sensing.

In some cases, individual tracker devices may be set up for different roles and different costs. Different tracker hardware may be used based on costs and user needs. For example, for high-value assets, relatively more expensive trackers with more features may be used. As an example of these additional features, the relatively more expensive trackers may offer more granular reporting intervals, less latency, more sensing, and the like as compared to less expensive trackers. As another example, for shipments with a large number of assets with relatively stringent environmental concerns, many lower cost trackers may be distributed throughout the assets. These lower cost trackers may have less features than more expensive trackers, but having more of the lower cost trackers may provide additional samples about conditions and experiences across the assets. In some cases, a mixture of trackers may be used.

Diagram 200 includes an example of a mixture of trackers 204, 208, and 212 that may fall in three capability groups. A first group of trackers may be represented by trackers 204. As indicated above, tracker 204 (such as tracking device 420 of FIG. 4) may be used at a case 202 level and may be relatively low cost, with relatively less memory, processing power, and/or battery power as compared to other trackers (e.g., trackers 208 and 212). The trackers 204 May be set up primarily for sensing the environment, with short-range communications to participate in a relatively small network of trackers.

A second group of trackers may be represented by trackers 208. Trackers 208 may be used at a pallet 206 level and may offer more capabilities, with relatively more memory, processing power, and/or battery power as compared to trackers 204, but relatively less memory, processing power, and/or battery power as compared to other trackers (e.g., trackers 212). In some cases, trackers 208 may be relatively more expensive than trackers 204, while less expensive than other trackers, such as tracker 212. Trackers 208 may be set up for additional sensing, data processing, and/or communications to maintain a relatively small network of trackers (e.g., a network of trackers 204 on a pallet) and coordinate with other trackers, such as other trackers 208 and 212.

A third group of trackers may be represented by trackers 212. Trackers 212 may be used at the delivery vehicle 210 level and may offer more capabilities, with relatively more memory, processing power, and/or battery power as compared to trackers 204 and 208. In some cases, trackers 212 may be tied into a power source for the delivery vehicle 210. Trackers 212 may be set up for data processing, location sensing, and/or enhanced communications capabilities for communicating with, and/or managing, multiple local networks of trackers, associate with additional devices, and communicating with remote servers via a wide area network.

Different networks of trackers may have a variety of different network topologies. In some cases, a single large network of trackers may be defined covering substantially all detectable/useable local trackers. However, such a network may not be the most reliable or easiest to sustain. In some cases, a network including multiple smaller networks of trackers may be used.

As previously mentioned, the shipping and delivery of assets (such as items or goods) can be an important activity for many users, such as parcel owners, which may be affiliated with various different business organizations. Assets that are sensitive and expensive may experience high severity shocks as a result of being mishandled in a warehouse or during transportation of the assets. Currently, manual inspections of the assets are carried out to detect and reject, or replace, any damaged assets that may have been damaged by experiencing a severe shock. Using manual inspections can be both time consuming and expensive. As such, improved systems and techniques for estimating shock severity experienced by assets during the handling and delivery of the assets can be beneficial.

Currently, some existing systems utilize peaks of measured acceleration of assets to determine shock severity experienced by assets. These systems, however, require the use of accelerometers with a large operating ranges (e.g., dynamic ranges) along with very high sampling rates in order to be able to effectively capture all of the peaks in acceleration. As such, these systems can be costly due to the use of expensive accelerometers (with large operating ranges), and these systems can require a high power consumption to maintain the high sampling rate.

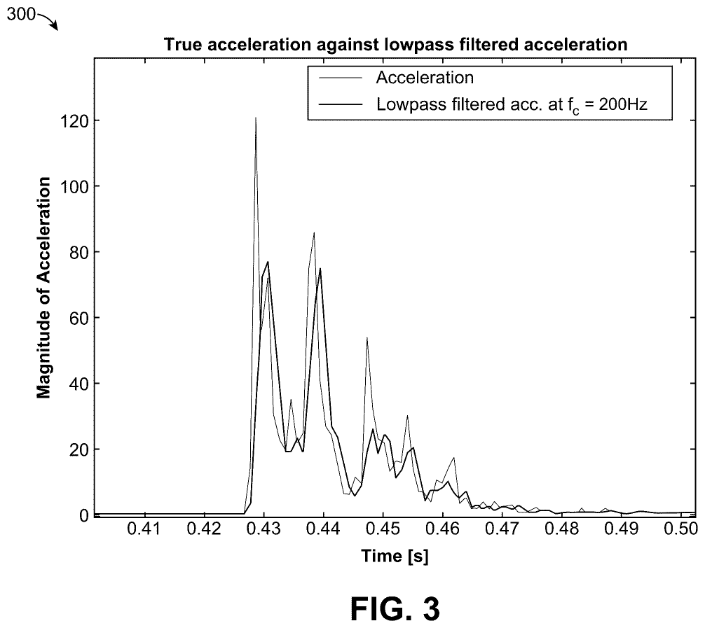

FIG. 3 shows an example of acceleration of an asset (e.g., packaged within box 410 of FIG. 4) captured by an accelerometer (e.g., included within sensors 122 of FIG. 1) of a tracking device (e.g., tracking device 420 of FIG. 4) over time. In particular, FIG. 3 is a graph 300 illustrating an example of the magnitude of acceleration measured over time. For the graph 300 of FIG. 3, the x-axis represents time in seconds(s), and the y-axis represents the magnitude of acceleration in gravitational-force, g-force (G).

In the graph 300 of FIG. 3, the original (measured) acceleration of the asset is plotted over time. As shown in the graph 300, the measured acceleration signal includes many transients (e.g., high peaks). These high peaks are utilized by some current systems to estimate shock severity. In order to attempt to capture all of these high peaks in the acceleration signal, an expensive accelerometer with a large operating range utilizing a high sampling rate needs to be employed by the tracking device. However, even when employing an expensive accelerometer with a large operating range (e.g., 32 GXL accelerometer) utilizing a high sampling rate (e.g., 1000 Hz), not all peaks in the acceleration may be effectively captured. As such, characterizing the severity of a shock to an asset based on peak acceleration values can be incomplete.

Also shown in the graph 300 of FIG. 3 is a resultant low pass filtered signal of the measured acceleration signal. The low pass filtered signal is obtained by filtering the measured acceleration signal through a low pass filter (LPF), such as an LPF with a cut-off frequency of 200 Hz. The low pass filtered signal is essentially a smoothed out version of the original signal.

In one or more aspects, the systems and techniques use velocity, rather than acceleration, to estimate shock severity to an asset. Velocity can be a representative metric for a shock severity estimate for an asset, and can be a more representative shock severity metric than acceleration, which can be an incomplete description of the shock. The velocity can be estimated by the tracker (e.g., tracking device), based on measured acceleration by the tracker of the asset. As such, the tracker uses velocity, rather than acceleration, as the key shock severity metric. When using velocity to determine shock severity for assets, shock severity estimates can still be effective, even when the trackers are using accelerometers with low ranges and low sampling rates. For example, the tracker can accurately determine a level of severity of shock experienced by an asset by using a 16 G accelerometer operating with a sampling rate of 100 Hz. Since the systems and techniques for estimating shock severity for assets can effectively employ trackers with accelerometers with low ranges and low sampling rates, the systems and techniques can provide a solution that is low cost as well as efficient in power consumption.

Velocity can be a more appropriate measure of shock severity than acceleration. There is a strict correlation between stress and velocity, and stress can represent the severity of the shock. The maximum stress (σₘₐₓ) is equal to material parameters density (ρ) and wave speed (c) multiplied by the maximum velocity (νₘₐₓ), where σₘₐₓ=ρ*c*νₘₐₓ. As such, there is a stress-velocity correlation because the stress (e.g., the maximum stress) is proportional to the velocity (e.g., the maximum velocity).

FIGS. 4, 5, and 6 together illustrate an example of a tracker (e.g., tracking device) utilizing velocity for estimating shock severity experienced by an asset. In particular, FIG. 4 is a diagram illustrating an example 400 of a heavy box 410, with an associated tracking device 420, falling onto a steel box 430. In FIG. 4, the heavy box 410 can include an asset (not shown), which may be expensive and/or fragile. A tracking device 420 is associated with (e.g., connected to or within) the heavy box 410. The tracking device 420 can include an accelerometer (e.g., within sensors 122 of FIG. 1). In one or more examples, the accelerometer may be a low cost accelerometer that has a narrow operating range (e.g., a 16 G accelerometer) utilizing a low sampling rate (e.g., 100 Hz) for a low power consumption.

In one or more examples, during handling of the heavy box 410, the heavy box 410 may fall (e.g., experience freefall) onto the steel box 430. During a period of time after the freefall of the heavy box 410, the accelerometer of the tracking device may capture (measure) the acceleration of the heavy box 410 (e.g., of the asset).

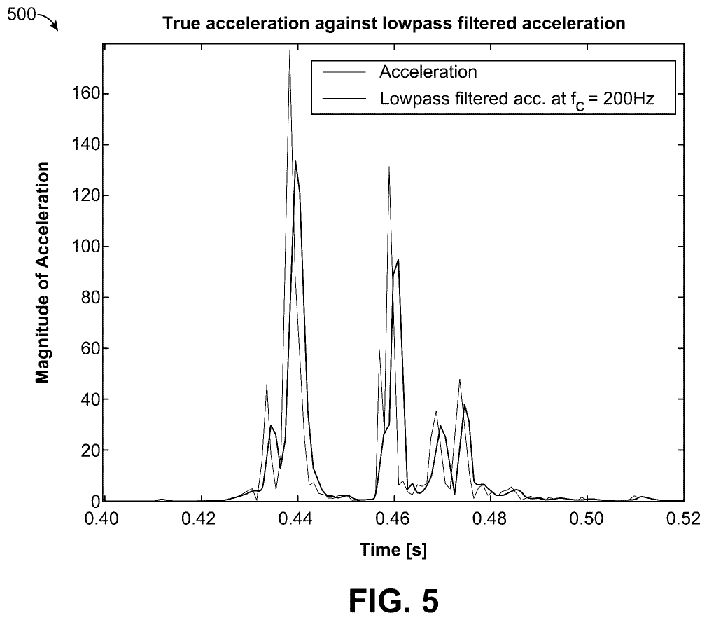

FIG. 5 shows an example of acceleration of the heavy box 410 captured by the accelerometer (e.g., included within sensors 122 of FIG. 1) of the tracking device (e.g., tracking device 420 of FIG. 4) over time after the freefall has occurred. In particular, FIG. 5 is a graph 500 illustrating an example of acceleration measured over time by the tracking device 420 of FIG. 4. In FIG. 5, for the graph 500, the x-axis represents time in seconds(s), and the y-axis represents the magnitude of acceleration in gravitational-force, g-force (G). In the graph 500, the acceleration signal plotted is the captured (measured) acceleration of the asset, by the tracker (e.g., tracking device), over time. As illustrated in the graph 500, the original signal includes many transients (e.g., high peaks).

Graph 500 of FIG. 5 also shows a resultant low pass filtered signal of the original signal. The low pass filtered signal is obtained by filtering the original signal through an LPF (e.g., an LPF with a cut-off frequency of 200 Hz). The low pass filtered signal is shown as being a smoothed out version of the original signal.

Since the systems and techniques utilize velocity rather than acceleration, for estimating shock severity to an asset, it is not necessary to capture all of the peaks in acceleration in order to accurately estimate the shock severity because the high frequency transients (e.g., the acceleration peaks) will have little influence over the velocity.

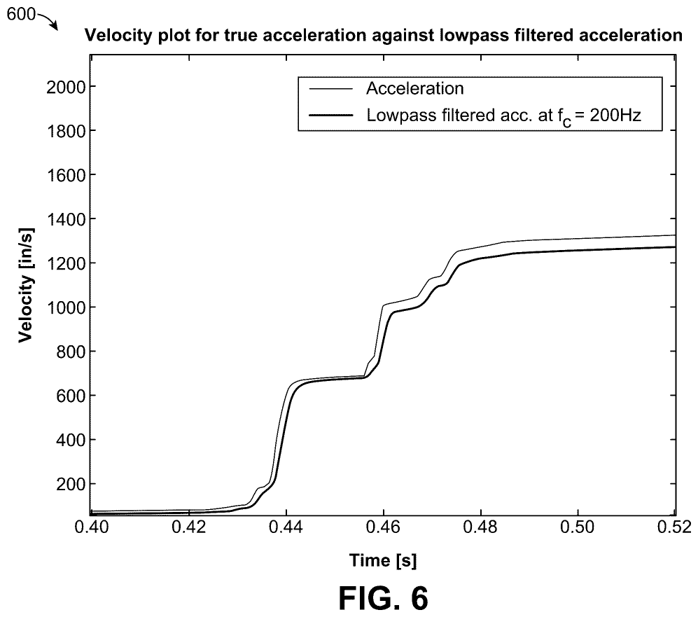

FIG. 6 shows an example of the impact velocity of the asset within the heavy box 410 of FIG. 4. FIG. 6 shows how the acceleration peaks do not have much influence in the velocity of an asset. In particular, FIG. 6 is a graph 600 illustrating an example of impact velocity over time estimated by the tracking device 420 of FIG. 4. In FIG. 6, for the graph 600, the x-axis represents time in seconds(s), and the y-axis represents velocity in inches per seconds (in/s) or (ips).

In the graph 600 of FIG. 6, the velocity derived from the acceleration signal of graph 500 of FIG. 5 is plotted, and the velocity derived from the low pass filtered signal of graph 500 of FIG. 5 is plotted. The velocity from the acceleration signal is derived by integrating the acceleration signal with respect to time, and the velocity from the low pass filtered signal is derived by integrating the low pass filtered signal with respect to time. As shown in the graph 600 of FIG. 6, the resulting velocities (e.g., the velocity from the acceleration signal and the velocity from the low pass filtered signal) are very similar to each other. As such, it is evident from the graph 600 that the high acceleration peaks within the original signal have little influence on the velocity of the asset.

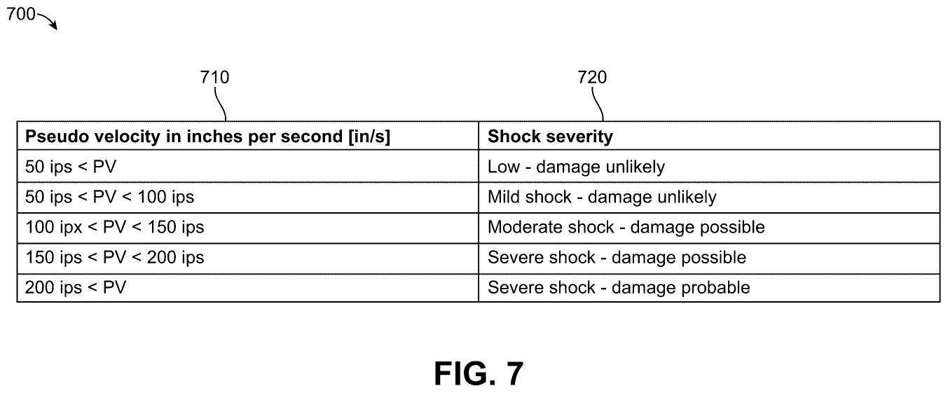

In one or more aspects, the velocity (e.g., energy of the shock) can be used to determine the severity of the shock to an asset. FIG. 7 shows examples of how to estimate shock severity to an asset by using the velocity of an asset. In particular, FIG. 7 is a table 700 illustrating an example of estimating levels of shock severity based on different velocities. In the table 700, a first column of the table 700 contains different velocities 710 in inches per second (ips), and a second column of the table 700 contains shock severity levels 720 associated with the velocities 710. As shown in the table 700, velocities over 100 ips can result in shock levels that can lead to damage to an asset. Such a table or scale will be heavily influenced by the material in which the tracker is located and the values at which a shock could be considered mild, moderate, or severe, should be experimentally determined by a user.

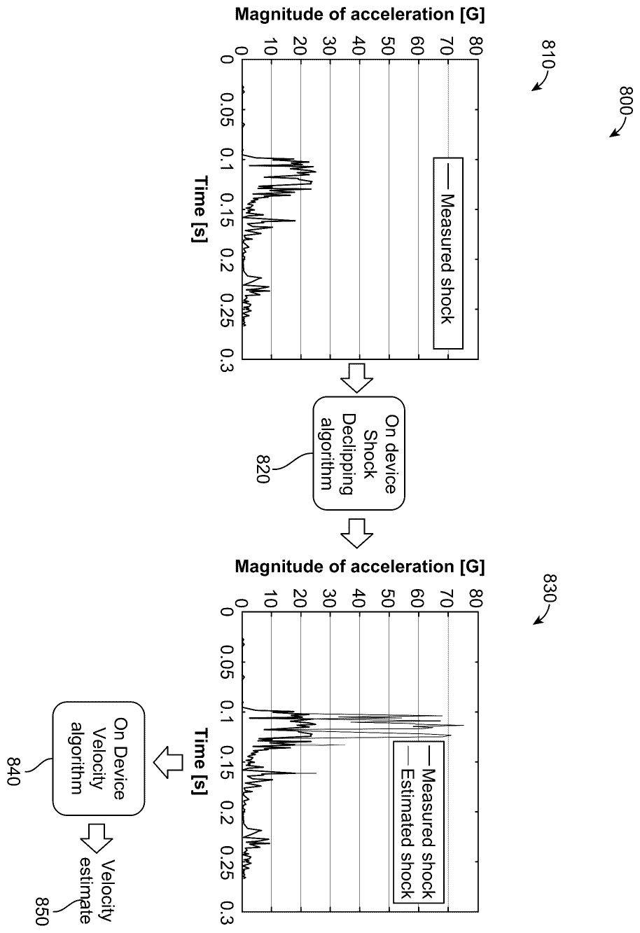

FIG. 8 shows an example process for estimating velocity for an asset. In particular, FIG. 8 is a diagram illustrating an example of a process 800 for estimating velocity from measured acceleration of an asset. During operation of the process 800, an accelerometer (e.g., within sensors 122 of FIG. 1) of a tracking device (e.g., tracking device 420 of FIG. 4) can capture (measure) acceleration for an asset over time. In one or more examples, the accelerometer may be a low cost accelerometer that has a narrow operating range (e.g., a 16 G accelerometer) utilizing a low sampling rate (e.g., 100 Hz) for a low power consumption.

The acceleration, which may consist of an x-axis, a y-axis, and a z-axis, is captured (measured), after which, the magnitude of the acceleration is computed. While not a strict requirement for shock analysis, transforming the measured acceleration into the magnitude of acceleration allows for an orientation-invariant shock analysis. The magnitude of acceleration computed by the tracking device is shown in graph 810. For the graph 810 of FIG. 8, the x-axis represents time in seconds(s), and the y-axis represents the magnitude of acceleration in gravitational-force, g-force (G). As shown in the graph 810, the acceleration has been severely clipped due to the limited operating range of the accelerometer.

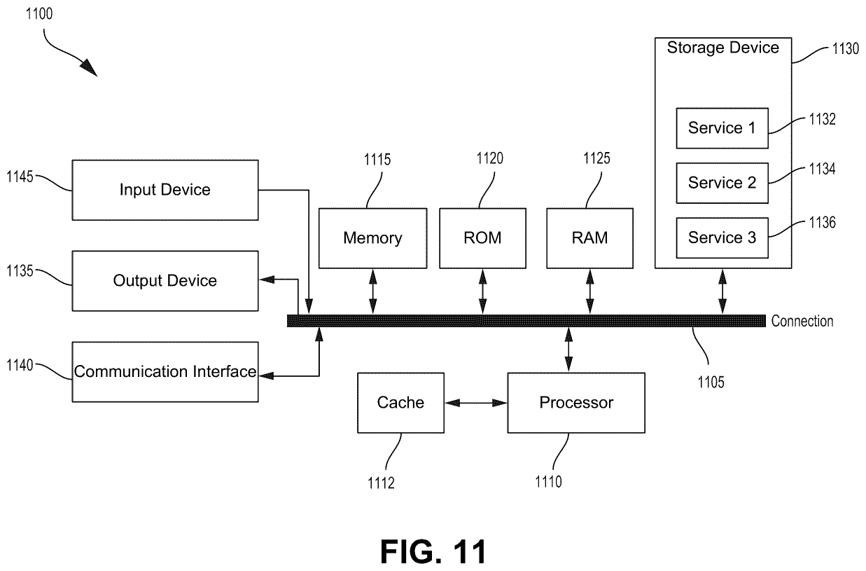

After the acceleration for the asset is captured (measured) by the tracking device, the captured acceleration (e.g., shown in graph 810) can be inputted into a shock declipping algorithm 820, which may be run by one or more processors (e.g., 102 CPU or sensor processor 114 of FIG. 1, or processor 1110 of FIG. 11) on the tracking device (e.g., tracking device 420 of FIG. 4). After the shock declipping algorithm 820 processes (declips) the captured (measured) acceleration, the shock declipping algorithm 820 will produce and output an estimated acceleration (e.g., an estimated reconstruction of the acceleration) for the asset.

The shock declipping algorithm 820 processes (declips) the captured (measured) acceleration by first identifying samples above (greater than) an arbitrary threshold close to the maximum operating range of the accelerometer. These identified samples and the immediate surrounding samples (e.g., neighboring samples, such as the samples immediately before and/or after the identified sample) are passed to a linear regression model or algorithm (or another similar signal processing model) to estimate and reconstruct the true acceleration value not captured by the accelerometer due to clipping. The linear regression model, of the shock declipping algorithm, was previously trained (e.g., via offline training) against many acceleration samples previously captured by a tracking device using an accelerometer with a much larger operating range, e.g., a 200 G accelerometer.

The graph 830 shows the captured (measured) acceleration as well as the estimated reconstruction of the acceleration outputted from the shock declipping algorithm 820. As shown in the graph 830, the estimated reconstruction of the acceleration is exhibiting much higher peaks in acceleration than the captured (measured) acceleration.

The one or more processors on the tracking device (e.g., tracking device 420 of FIG. 4) can run a velocity algorithm 840 to process the estimated reconstruction of the acceleration (from the declipping algorithm 820) to determine a velocity estimate 850 for the asset. The velocity estimate 850 for the asset can be derived (by the velocity algorithm 840) by integrating the estimated reconstruction of the acceleration with respect to time. An example of a velocity estimate 850 is shown in the graph 600 of FIG. 6. After the velocity estimate 850 is determined, a level of severity of shock experience by the asset can be determined, based on the value of the velocity estimate 850 (e.g., by using table 700 of FIG. 7).

In one or more examples, the model for determining the estimated velocity for an asset (e.g., which includes the declipping algorithm 820 and the velocity algorithm 840) is very small, such as less than 0.5 kilobytes (KB). As such, the model has a small memory footprint and has low power consumption.

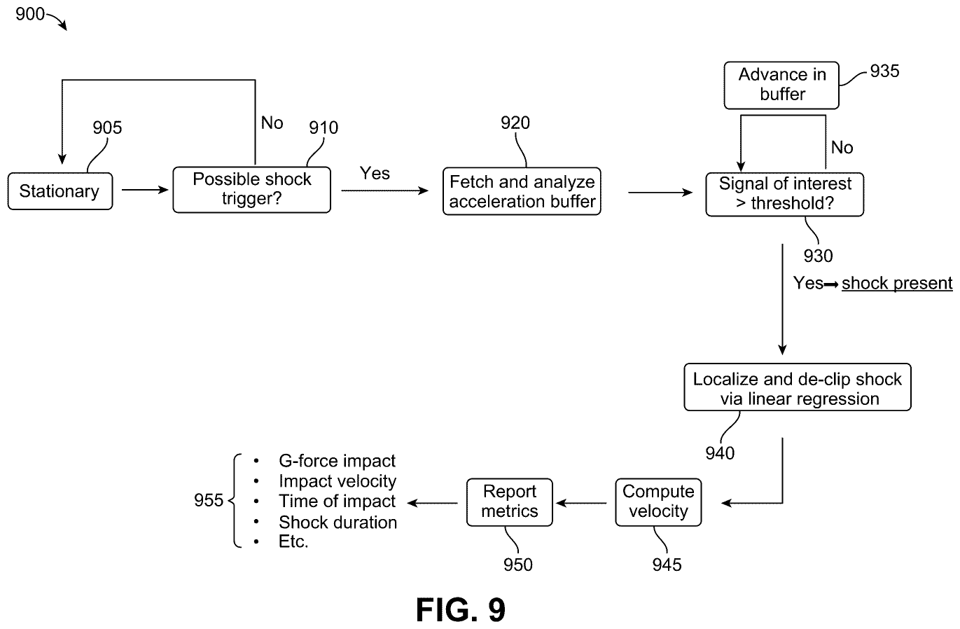

In one or more aspects, the estimated velocity can enable further value added analytics on a customer cloud (e.g., cloud server), such as a fall surface classification. For example, a tracking device (e.g., tracking device 420 of FIG. 4) can determine and communicate (e.g., to a customer cloud and/or a user) temporal information in addition to G-force impact and impact velocity. In some examples, the temporal information can include time of impact and/or shock duration. FIG. 9 shows an example process for determining shock severity metrics by using estimated velocity for an object. In particular, FIG. 9 is a diagram illustrating an example of a process 900 for determining shock severity metrics 955 for an asset.

During operation of the process 900 of FIG. 9, an accelerometer (e.g., within sensors 122 of FIG. 1) of a tracking device (e.g., tracking device 420 of FIG. 4) can capture (measure) acceleration for an asset over time. The accelerometer can be a low cost accelerometer that has a narrow operating range (e.g., a 16 G accelerometer) utilizing a low sampling rate (e.g., 100 Hz) for a low power consumption.

After the acceleration for the asset is captured (measured) by the tracking device, the one or more processors on the tracking device (e.g., tracking device 420 of FIG. 4) can attempt to determine (e.g., determine whether the asset has experienced) an event preceding a probable shock at block 910, such as a based on detecting a trigger (e.g., a freefall trigger). Such a trigger could be any signal which is likely to precede a shock and could include, but is not limited to, a freefall, or an acceleration (e.g., a sudden acceleration), or a deceleration (e.g., a sudden deceleration). If the tracking device determines that the asset has not experienced an event likely to precede a shock (e.g., not detected a freefall), the process 900 proceeds to being stationary 905 (e.g., idle), until the process 900 proceeds back to an event detection determination at block 910, after another capture (measure) of acceleration over time.

However, if the tracking device determines that the asset has experienced an event that is likely to precede a shock (e.g., detected a freefall), such as based on detecting a trigger (e.g., a freefall trigger), the one or more processors on the tracking device (e.g., tracking device 420 of FIG. 4) can fetch and analyze 920 the captured acceleration for a period of time (e.g., for 10 seconds of time). The captured acceleration may be stored within a buffer (e.g., memory 118 of FIG. 1, or memory 1115 or RAM 1125 of FIG. 11).

The one or more processors on the tracking device (e.g., tracking device 420 of FIG. 4) can analyze the a signal of interest (e.g., the captured acceleration itself or a signal of interest related to or associated with the captured acceleration) for a period of time (e.g., for 10 seconds of time) to determine whether the acceleration, or a separate signal of interest such as the variance or jerk, captured for the period of time (e.g., for 10 seconds of time) has a value is greater than a threshold 930 (e.g., a predetermined variance threshold value, such as a value between 5 and 500). If the tracking device determines that the signal of interest, which may be the acceleration itself or a separate signal related or associated with to the acceleration, captured for the period of time (e.g., for 10 seconds of time) does not have a value that is greater than the threshold, the one or more processors on the tracking device (e.g., tracking device 420 of FIG. 4) can fetch captured acceleration for N number of seconds (e.g., one second, one and a half seconds, two seconds, etc.) advanced in the buffer 935, and determine whether the signal of interest for the N number of seconds is greater than the threshold 930.

However, if the tracking device determines that the signal of interest captured for the period of time (e.g., for 10 seconds of time) does have a value that is greater than the threshold, the one or more processors on the tracking device (e.g., tracking device 420 of FIG. 4) can determine that a shock is present (e.g., the asset experienced a shock). The one or more processors on the tracking device (e.g., tracking device 420 of FIG. 4) can localize the shock (e.g., by looking for where there is a jump in the signal of interest), declip the shock via linear regression 940 (e.g., perform linear regression on the localized acceleration to generate an estimated acceleration), and determine (compute) the estimated velocity 945 (estimated shock severity) by integrating the reconstructed acceleration with respect to time.

After the tracking device has reconstructed the acceleration estimate (shock estimate), the one or more processors on the tracking device (e.g., tracking device 420 of FIG. 4) can analyze the reconstructed acceleration estimate (shock estimate) to determine shock severity metrics 955 for the asset. The tracking device can then report 950 (transmit) the shock severity metrics 955 to a customer cloud (e.g., cloud server) and/or a user. In one or more examples, the shock severity metrics 955 can include, but are not limited to, G-force impact, impact velocity, time of impact, and/or shock duration.

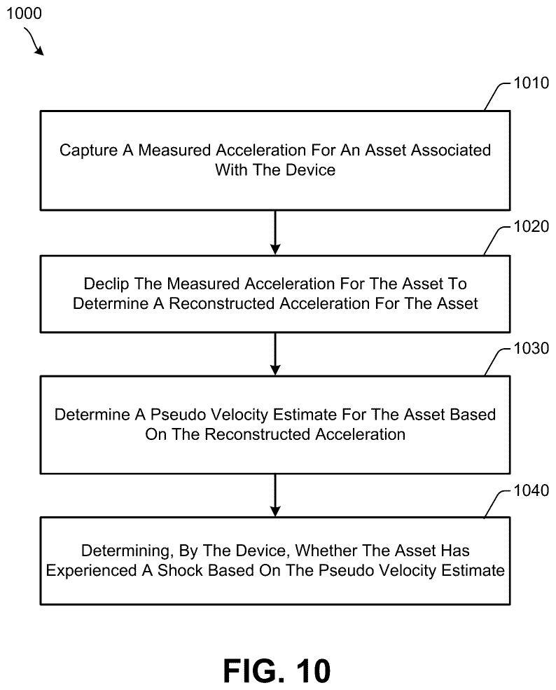

FIG. 10 is a flow chart illustrating an example of a process 1000 for estimating shock severity. The process 1000 can be performed by a device (e.g., tracking device 420 of FIG. 4) or by a component or system (e.g., a chipset) of the device. The operations of the process 1000 may be implemented as software components that are executed and run on one or more processors (e.g., processor 1110 of FIG. 11 or other processor(s)). Further, the transmission and reception of signals by the device (e.g., tracking device 420 of FIG. 4) in the process 1000 may be enabled, for example, by one or more antennas and/or one or more transceivers (e.g., wireless transceiver(s)).

At block 1010, the device (or component thereof), such as tracking device 420 of FIG. 4, can capture a measured acceleration for an asset associated with the device. At block 1020, the device can determine the measured acceleration (e.g., such as shown in graph 810 of FIG. 8) for the asset (e.g., which may be included within box 410 of FIG. 4) to determine a reconstructed acceleration (e.g., an estimated reconstruction of the acceleration, such as shown in graph 830 of FIG. 8) for the asset.

At block 1030, the device can determine a velocity estimate (e.g., velocity estimate 850 of FIG. 8, and compute velocity 945 of FIG. 9) for the asset based on the reconstructed acceleration. In one illustrative example, the velocity estimate for the asset can be derived (e.g., by the velocity algorithm 840 of FIG. 8) by integrating the estimated reconstruction of the reconstructed acceleration with respect to time. At block 1040, the device can determine whether the asset has experienced a shock (e.g., a severe shock) based on the velocity estimate (e.g., by utilizing table 700 of FIG. 7).

In one or more examples, the device can detect a trigger (e.g., determining the shock trigger at block 910 of FIG. 9) based on the measured acceleration for the asset. In some examples, the trigger is detected when the asset experiences a freefall, an acceleration (e.g., a sudden acceleration), or a deceleration (e.g., a sudden deceleration). In one or more examples, the device can determine a signal of interest associated with the measured acceleration, based on detecting the trigger. In some examples, the device can determine whether a value of the signal of interest is greater than a variance threshold value. In one or more examples, the declipping of the measured acceleration is performed based on a determination that the value of the signal of interest is greater than the variance threshold value.

In one or more examples, the declipping of the measured acceleration includes applying a signal processing algorithm (e.g., declipping algorithm 820 of FIG. 8) on acceleration samples of the measured acceleration that have values greater than a threshold and neighboring samples of the acceleration samples to obtain an estimated acceleration. In some cases, the threshold is associated with a maximum of an operating range of an accelerometer and neighboring samples of the acceleration samples. In some examples, the signal processing algorithm is a linear regression model. In one or more examples, the linear regression model is trained against previously captured acceleration samples.

In one or more examples, the device can determine one or more shock severity metrics (e.g., shock severity metrics 955 of FIG. 9) for the asset based on the reconstructed acceleration. In some examples, the device can transmit the one or more shock severity metrics to at least one of a customer cloud or a user. In one or more examples, the one or more shock severity metrics can include a G-force impact, an impact velocity, a time of impact, and/or a shock duration for the asset.

In one or more examples, the device is a tracking device comprising an accelerometer (e.g., which may be included within sensors 122 of FIG. 1). In one or more examples, the velocity estimate is a representative metric for the shock severity estimate.

The device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the device configured to perform the process 1000 of FIG. 10 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a block diagram illustrating an example of a computing system 1100, which may be employed by the disclosed systems and techniques for estimating shock severity. In particular, FIG. 11 illustrates an example of computing system 1100, which can be, for example, any computing device making up an internal computing system, a remote computing system, a tracking device, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LIDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), crasable programmable read-only memory (EPROM), electrically crasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor May be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for shock severity estimation, the apparatus comprising: at least one memory; and at least one processor coupled to the at least one memory and configured to: capture a measured acceleration for an asset associated with the apparatus; declip the measured acceleration for the asset to determine a reconstructed acceleration for the asset; determine a velocity estimate for the asset based on the reconstructed acceleration; and determine whether the asset has experienced a shock based on the velocity estimate.

Aspect 2. The apparatus of Aspect 1, wherein the at least one processor is configured to detect a trigger based on the measured acceleration for the asset.

Aspect 3. The apparatus of Aspect 2, wherein the at least one processor is configured to detect the trigger when the asset experiences one of a freefall, an acceleration, or a deceleration.

Aspect 4. The apparatus of any one of Aspects 2 or 3, wherein the at least one processor is configured to determine a signal of interest associated with the measured acceleration based on detecting the trigger.

Aspect 5. The apparatus of Aspect 4, wherein the at least one processor is configured to determine whether a value of the signal of interest is greater than a variance threshold value.

Aspect 6. The apparatus of Aspect 5, wherein the at least one processor is configured to declip the measured acceleration based on a determination that the value of the signal of interest is greater than the variance threshold value.

Aspect 7. The apparatus of any one of Aspects 1 to 6, wherein, to declip the measured acceleration, the at least one processor is configured to apply a signal processing algorithm on acceleration samples of the measured acceleration that have values greater than a threshold and neighboring samples of the acceleration samples to obtain an estimated acceleration, wherein the threshold is associated with a maximum of an operating range of an accelerometer.

Aspect 8. The apparatus of Aspect 7, wherein the signal processing algorithm is a linear regression model.

Aspect 9. The apparatus of Aspect 8, wherein the linear regression model is trained against previously captured acceleration samples.

Aspect 10. The apparatus of any one of Aspects 1 to 9, wherein the at least one processor is configured to determine one or more shock severity metrics for the asset based on the reconstructed acceleration.

Aspect 11. The apparatus of Aspect 10, wherein the at least one processor is configured to output the one or more shock severity metrics for transmission to at least one of a customer cloud or a user.

Aspect 12. The apparatus of any one of Aspects 10 or 11, wherein the one or more shock severity metrics comprise at least one of a G-force impact, an impact velocity, a time of impact, or a shock duration for the asset.

Aspect 13. The apparatus of any one of Aspects 1 to 12, wherein the apparatus is a tracking device comprising an accelerometer.

Aspect 14. The apparatus of any one of Aspects 1 to 13, wherein the velocity estimate is a representative metric for an estimate of severity of the shock.

Aspect 15. A method for shock severity estimation performed by a device, the method comprising: capturing, by the device, a measured acceleration for an asset associated with the device; declipping, by the device, the measured acceleration for the asset to determine a reconstructed acceleration for the asset; determining, by the device, a velocity estimate for the asset based on the reconstructed acceleration; and determining, by the device, whether the asset has experienced a shock based on the velocity estimate.

Aspect 16. The method of Aspect 15, further comprising detecting, by the device, a trigger based on the measured acceleration for the asset.

Aspect 17. The method of Aspect 16, wherein the trigger is detected when the asset experiences one of a freefall, an acceleration, or a deceleration.

Aspect 18. The method of any one of Aspects 16 or 17, further comprising determining, by the device, a signal of interest associated with the measured acceleration based on detecting the trigger.

Aspect 19. The method of Aspect 18, further comprising determining, by the device, whether a value of the signal of interest is greater than a variance threshold value.

Aspect 20. The method of Aspect 19, wherein declipping of the measured acceleration is performed based on a determination that the value of the signal of interest is greater than the variance threshold value.

Aspect 21. The method of any one of Aspects 15 to 20, wherein declipping of the measured acceleration comprises applying a signal processing algorithm on acceleration samples of the measured acceleration that have values greater than a threshold and neighboring samples of the acceleration samples to obtain an estimated acceleration, wherein the threshold is associated with a maximum of an operating range of an accelerometer.

Aspect 22. The method of Aspect 21, wherein the signal processing algorithm is a linear regression model.

Aspect 23. The method of Aspect 22, wherein the linear regression model is trained against previously captured acceleration samples.

Aspect 24. The method of any one of Aspects 15 to 23, further comprising determining, by the device, one or more shock severity metrics for the asset based on the reconstructed acceleration.

Aspect 25. The method of Aspect 24, further comprising transmitting, by the device, the one or more shock severity metrics to at least one of a customer cloud or a user.

Aspect 26. The method of any one of Aspects 24 or 25, wherein the one or more shock severity metrics comprise at least one of a G-force impact, an impact velocity, a time of impact, or a shock duration for the asset.

Aspect 27. The method of any one of Aspects 15 to 26, wherein the device is a tracking device comprising an accelerometer.

Aspect 28. The method of any one of Aspects 15 to 27, wherein the velocity estimate is a representative metric for an estimate of severity of the shock.

Aspect 29. A non-transitory computer-readable storage medium comprising instructions stored thereon which, when executed by at least one processor, causes the at least one processor to perform operations according to any one of Aspects 14 to 28.

Aspect 30. An apparatus for processing image data, comprising one or more means for performing operations according to any one of Aspects 14 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for shock severity estimation, the apparatus comprising:
at least one memory; and
at least one processor coupled to the at least one memory and configured to:
capture a measured acceleration for an asset associated with the apparatus;
declip the measured acceleration for the asset to determine a reconstructed acceleration for the asset;
determine a velocity estimate for the asset based on the reconstructed acceleration; and
determine whether the asset has experienced a shock based on the velocity estimate.

2. The apparatus of claim 1, wherein the at least one processor is configured to detect a trigger based on the measured acceleration for the asset.

3. The apparatus of claim 2, wherein the at least one processor is configured to detect the trigger when the asset experiences one of a freefall, an acceleration, or a deceleration.

4. The apparatus of claim 2, wherein the at least one processor is configured to determine a signal of interest associated with the measured acceleration based on detecting the trigger.

5. The apparatus of claim 4, wherein the at least one processor is configured to determine whether a value of the signal of interest is greater than a variance threshold value.

6. The apparatus of claim 5, wherein the at least one processor is configured to declip the measured acceleration based on a determination that the value of the signal of interest is greater than the variance threshold value.

7. The apparatus of claim 1, wherein, to declip the measured acceleration, the at least one processor is configured to apply a signal processing algorithm on acceleration samples of the measured acceleration that have values greater than a threshold and neighboring samples of the acceleration samples to obtain an estimated acceleration, wherein the threshold is associated with a maximum of an operating range of an accelerometer.

8. The apparatus of claim 7, wherein the signal processing algorithm is a linear regression model.

9. The apparatus of claim 8, wherein the linear regression model is trained against previously captured acceleration samples.

10. The apparatus of claim 1, wherein the at least one processor is configured to determine one or more shock severity metrics for the asset based on the reconstructed acceleration.

11. The apparatus of claim 10, wherein the at least one processor is configured to output the one or more shock severity metrics for transmission to at least one of a customer cloud or a user.

12. The apparatus of claim 10, wherein the one or more shock severity metrics comprise at least one of a G-force impact, an impact velocity, a time of impact, or a shock duration for the asset.

13. The apparatus of claim 1, wherein the apparatus is a tracking device comprising an accelerometer.

14. The apparatus of claim 1, wherein the velocity estimate is a representative metric for an estimate of severity of the shock.

15. A method for shock severity estimation performed by a device, the method comprising:
capturing, by the device, a measured acceleration for an asset associated with the device;
declipping, by the device, the measured acceleration for the asset to determine a reconstructed acceleration for the asset;
determining, by the device, a velocity estimate for the asset based on the reconstructed acceleration; and
determining, by the device, whether the asset has experienced a shock based on the velocity estimate.

16. The method of claim 15, further comprising detecting, by the device, a trigger based on the measured acceleration for the asset.

17. The method of claim 16, wherein the trigger is detected when the asset experiences one of a freefall, an acceleration, or a deceleration.

18. The method of claim 16, further comprising determining, by the device, a signal of interest associated with the measured acceleration based on detecting the trigger.

19. The method of claim 18, further comprising determining, by the device, whether a value of the signal of interest is greater than a variance threshold value.

20. The method of claim 19, wherein declipping of the measured acceleration is performed based on a determination that the value of the signal of interest is greater than the variance threshold value.

21. The method of claim 15, wherein declipping of the measured acceleration comprises applying a signal processing algorithm on acceleration samples of the measured acceleration that have values greater than a threshold and neighboring samples of the acceleration samples to obtain an estimated acceleration, wherein the threshold is associated with a maximum of an operating range of an accelerometer.

22. The method of claim 21, wherein the signal processing algorithm is a linear regression model.

23. The method of claim 22, wherein the linear regression model is trained against previously captured acceleration samples.

24. The method of claim 15, further comprising determining, by the device, one or more shock severity metrics for the asset based on the reconstructed acceleration.

25. The method of claim 24, further comprising transmitting, by the device, the one or more shock severity metrics to at least one of a customer cloud or a user.

26. The method of claim 24, wherein the one or more shock severity metrics comprise at least one of a G-force impact, an impact velocity, a time of impact, or a shock duration for the asset.

27. The method of claim 15, wherein the device is a tracking device comprising an accelerometer.

28. The method of claim 15, wherein the velocity estimate is a representative metric for an estimate of severity of the shock.
